(19) United States
(12) Patent Application Publication
(10) Pub. No.: US 2006/0289214 A1
(43) Pub. Date: Dec. 28, 2006

(54) DRIVING DEVICE FOR A HYBRID VEHICLE, AND A HYBRID VEHICLE HAVING THE SAME

(76) Inventors: Arai Katsuhiro, Shizuoka-ken (JP); Tetsushi Saitou, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/426,218

(22) Filed: Jun. 23, 2006

(30) Foreign Application Priority Data
Jun. 23, 2005 (JP) 2005-184141

(51) Int. Cl. B60K 1/00

(52) U.S. Cl. 180/65.4

(57) ABSTRACT

An engine produces power, which is distributed by a power distribution device to an electric generator and a rear wheel. A motor produces power other than that produced by the engine to drive the rear wheel, and also functions as an electric generator. A control unit drives the electric generator and the motor using electricity from a battery to start up the engine. When starting up the engine, the control unit drives a decompression device provided in the engine to reduce the compression pressure inside a cylinder from the moment when cranking of the engine is started.

### CROSS-REFERENCE TO RELATED APPLICATIONS

The present application is based on and claims priority under 35 U.S.C. 119 to Japanese Patent Application No. 2005-184141, filed on Jun. 23, 2005, the entire contents of which are incorporated by reference and should be considered part of this specification.

### BACKGROUND OF THE INVENTION

1. Field of the Invention

The present invention relates to a driving device for a hybrid vehicle that incorporates a plurality of driving sources to run, and to a hybrid vehicle having the same.

2. Description of the Related Art

There is an interest, from an environmental point of view, to reduce the discharge of pollutants from engine-driven vehicles as much as possible. In consideration of this, hybrid vehicles have been developed which utilize an electric motor (e.g., a rotary electric machine) in addition to an internal combustion engine to drive a driving wheel or driving wheels of the vehicle using the electric motor.

Hybrid vehicles achieve reductions in noise and air pollution by using mainly the electric motor as the power source for the vehicle while the vehicle operates steadily. The hybrid vehicles additionally use the engine to avoid the drawbacks of electric vehicles driven solely by an electric motor. For example, the additional use of the engine avoids problems such as the limited running distance per battery charge, and the inadequate response during rapid start-up, high-load operation and high-speed running conditions due to small power generation output from the electric motor.

Hybrid vehicles include parallel hybrid vehicles, in which at least one of an internal combustion engine and an electric motor can be switched on and off depending on the running condition of the vehicle and the remaining amount of electricity in a battery (e.g., secondary battery) charged by an electric generator. Another type of hybrid vehicles is a series hybrid vehicle, in which a driving wheel of the vehicle is driven by a drive motor, which in turn is driven solely by electricity generated by an electric generator that is driven by an internal combustion engine.

Series-parallel hybrid vehicles also have been developed, a combination of the series hybrid and the parallel hybrid vehicles, in which engine output is distributed by a power distribution device using a planetary gear mechanism to drive a driving wheel, as disclosed for example in Japanese Patent No. JP 2003-191761.

The power distribution device splits engine power into a vehicle driving force to be mechanically transmitted to the driving wheel to drive the driving wheel directly, and an electricity generation driving force to actuate the electric generator to generate electricity. That is, the power distribution device uses a portion of engine power to rotate the driving wheel and another portion to drive the electric generator. The electricity generated by the electric generator is supplied to the electric motor to run the motor, and the power produced by the motor in response to the supplied electricity is added to the vehicle driving force to drive the driving wheel.

The use of a hybrid drive unit using the power distribution device, as described above, allows the hybrid vehicle to operate the engine at the most preferable fuel consumption rate.

In general, in the hybrid vehicles using the power distribution device described above, the engine is started-up after the vehicle starts running with the motor power. When the engine is started while the motor is outputting driving force, a part of the torque output from the motor is distributed to crank the engine according to the torque distribution ratio of planet gears for outputting power as the motor rotates.

When starting-up the engine, in general, a crankshaft of the engine is rotated externally, such as by a starter motor. At this time, significant torque is required to rotate (crank) the crankshaft, since the in-cylinder pressure of the engine must be reduced.

Thus, in the hybrid vehicles using the power distribution device, a sudden decrease in the driving wheel propulsion force which propels the driving wheel impacts the vehicle operation, even when the motor is outputting constant torque.

Such impact can be effectively lessened by reducing the load (pumping loss) with which the in-cylinder pressure of the engine is reduced. For example, in the hybrid vehicles using the power distribution device, a variable valve timing mechanism is used for that purpose. However, the in-cylinder pressure cannot be fully reduced through the entire compression stroke of the engine because of limitations on the phase range within which valve timing can be varied, even with the use of the variable valve timing mechanism.

The remaining in-cylinder pressure impacts engine operation in the form of a pumping loss when starting-up the engine. This impact does not affect the operation by an operator in the case of heavy vehicles such as automobiles.

In recent years, the drive unit with the power distribution device described above has also been applied to motorcycles.

The operating direction of a motorcycle is determined by an increase and decrease in the driving wheel propulsion force that occurs while the vehicle is turning, based on the principle of two-wheel operation. Thus, it is necessary to differentiate an increase and decrease in the driving wheel propulsion force intended by the operator and those not intended by the operator. The unintentional increase and decrease are preferably as small as possible since they can affect the operating state interpreted or sensed by the operator.

That is, in the case where the hybrid drive unit using the power transmission device disclosed in JP 2003-191761 is mounted on a motorcycle, impact at engine start-up is an unintentional increase and decrease in propulsion force that needs to be decreased. This is because even an impact which does not affect automobiles can be sensed by the operator of motorcycles as an unintentional increase and decrease in propulsion force.

To eliminate such an impact, the capacity of the battery for supplying a current to the motor, and the torque produced by the motor, can be increased.

However, a motorcycle has a limited mounting space compared to an automobile and thus cannot acommodate a battery which becomes larger as its charging capacity increases or a larger motor for producing increased torque.

Thus, there is a need for a driving device for a hybrid vehicle mountable on a motorcycle to provide a hybrid vehicle in which impact on the operator at engine startup can be reduced.

### SUMMARY OF THE INVENTION

In accordance with one aspect of the present invention, a driving device for a hybrid vehicle is provided. The driving device preferably is mountable on a motorcycle or like vehicle that can lessen an increase and decrease in propulsion force not intended by an operator, even when a rotary electric machine for running the vehicle is outputting constant torque, thereby allowing the operator to easily operate the vehicle and to provide a hybrid vehicle.

An aspect of the present invention involves a driving device for a hybrid vehicle comprising an internal combustion engine configured to produce power, a first rotary electric machine configured to operate at least as an electric generator, and a power distribution device configured to distribute the power produced by the engine to at least one of the first rotary electric machine and a driving wheel. A second rotary electric machine is configured to operate at least as an electric motor, with the second rotary electric machine producing power to drive the driving wheel. A storage battery supplies electricity to the first rotary electric machine and the second rotary electric machine. A pressure reduction device is disposed in communication with the engine and is configured to reduce a compression pressure inside a cylinder of the engine. The vehicle also includes a control device that is configured to control the first rotary electric machine and the second rotary electric machine during start-up of the engine, and is also configured to operate the pressure reduction device to reduce the compression pressure inside the cylinder during engine start-up.

Another aspect of the invention involves a hybrid vehicle having an internal combustion engine and an electric motor as power sources in which a driving wheel is driven by at least one of the engine and the motor. The vehicle also comprises a control device that controls operation of the motor and startup of the engine when the motor is driven. A pressure reduction device is provided in the engine for reducing a compression pressure inside a cylinder of the engine during engine startup. The control device is configured to control the pressure reduction device when starting up the engine to reduce the compression pressure inside the cylinder from a moment when the cranking of the engine is started.

An additional aspect of the present invention involves a method for operating a hybrid vehicle having an internal combustion engine and an electric motor as power sources in which a driving wheel is driven by at least one of the engine and the motor. The method comprising detecting a speed of the hybrid vehicle, detecting an accelerator position, detecting a speed of an engine of the hybrid vehicle, determining whether to start-up the engine based on the detected vehicle speed and accelerator position and determining whether or not the detected engine speed is higher than a predetermined resonance rotational speed of the engine, and higher than a proper-for-startup rotational speed proper for engine startup. The method also involves communicating one or more drive commands when the startup of the engine is determined to control a rotational speed of a first rotary electric machine to reduce pressure in a cylinder of the engine and to close a throttle valve of the engine from the moment when cranking of the engine is started, and to control a second rotary electric machine to prevent power transmission from a second rotary element to a third rotary element until the detected engine speed is determined to be higher than the resonance rotational speed.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely examples and are not intended to limit the invention. The drawings include the following 11 figures.

FIG. 1 is a schematic left side view of a scooter-type motorcycle incorporating one embodiment of a driving device for a hybrid vehicle.

FIG. 2 is a schematic cross-sectional view of the general construction of a drive unit of the scooter-type motorcycle shown in FIG. 1.

FIG. 3 is a collinear chart of an electric generator, an engine and a motor in a control device for a hybrid vehicle according to one embodiment.

FIG. 4 is a block diagram illustrating the general construction of the control device for a hybrid vehicle according to one embodiment.

FIG. 5 is a functional block diagram of a control unit outlining the functions of a hybrid control unit related to engine startup.

FIG. 6 is a diagram of velocity versus drive force, illustrating an example of efficiency optimization information.

FIG. 7 is a diagram of frequency versus displacement, illustrating an example of resonance information.

FIG. 8 is a diagram illustrating the rotational angle of a crankshaft indicating ignition timing.

FIG. 9 is a timing chart illustrating an engine startup control process using the control device for a hybrid vehicle according to one embodiment of the present invention.

FIG. 10 is a flowchart outlining the engine startup control process, according to one embodiment.

FIG. 11 is a diagram showing electric generator characteristics for explaining the process of starting up the engine from a vehicle stationary state performed by the driving device of this embodiment.

### DETAILED DESCRIPTION OF THE PREFERRED EMBODIMENTS

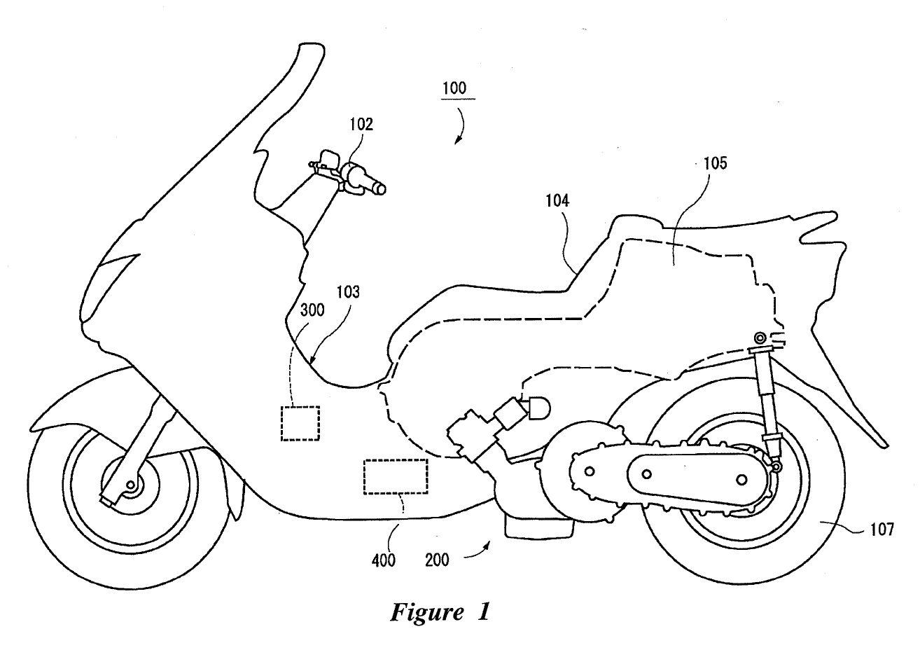

FIG. 1 is a schematic left side view of a scooter-type motorcycle 100 as an example of a hybrid vehicle incorporating a driving device for a hybrid vehicle according to an embodiment of the present invention. While the driving device is illustrated in connection with a scooter-type motorcycle, the driving device can be used with other types of vehicles as well.

The hybrid vehicle shown in FIG. 1 is a series-parallel hybrid scooter-type motorcycle in which a wheel is driven using an internal combustion engine and/or an electric motor as power sources. Specifically, in the hybrid vehicle (hereinafter referred to as “scooter-type motorcycle”), the engine power is split by a power split mechanism into two parts with a variable split ratio, of which one part is used to drive the wheel directly and the other part is used to generate electricity. In this embodiment, “front,” “rear,” “left,” “right,” “upper” and “lower” refer to the front, rear, left, right, upper and lower directions as viewed by the rider.

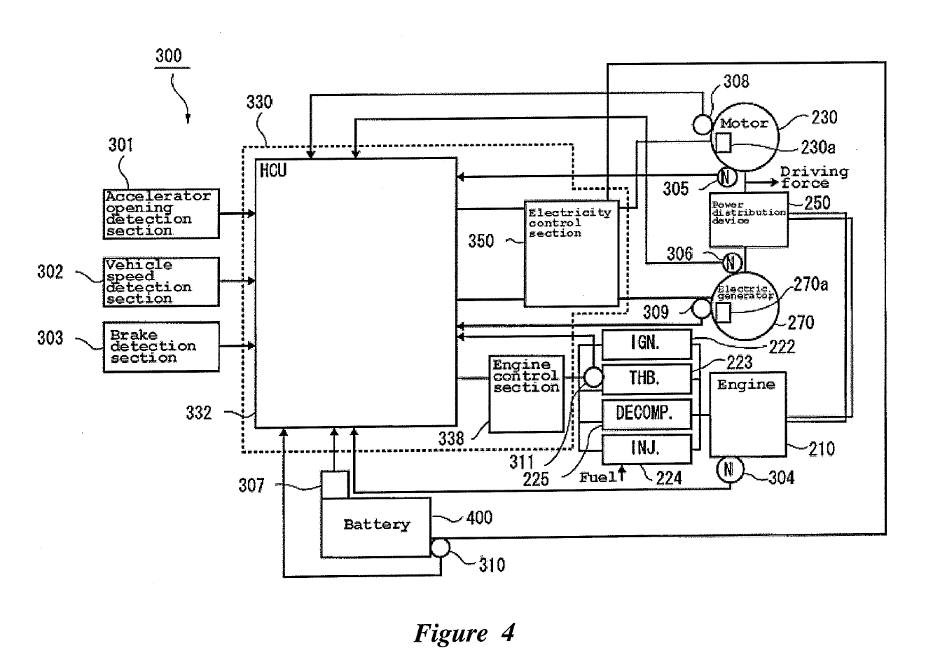

The scooter-type motorcycle 100 shown in FIG. 1 includes a vehicle body 103 for rotatably supporting handlebars 102 at a front part thereof, and a tandem seat 104 and a trunk space 105 located vertically on a rear side of the vehicle body 103. A drive unit 200 is located below the trunk space 105. The scooter-type motorcycle 100 includes a driving device that includes the drive unit 200 and a drive control device (hereinafter referred to as “control device”) 300 (see FIG. 4) for controlling the drive unit 200.

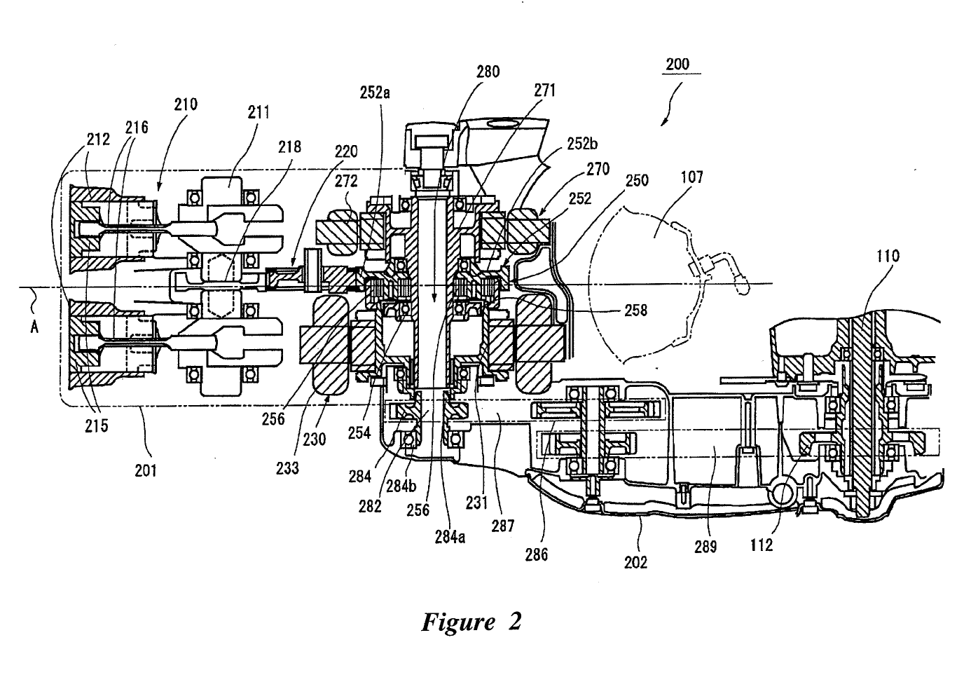

FIG. 2 is a schematic cross-sectional view illustrating the general construction of the drive unit 200 of the scooter-type motorcycle 100 shown in FIG. 1.

The drive unit 200 shown in FIG. 2 includes in its unit body 201 an internal combustion engine 210, an electric motor (e.g., second rotary electric machine) 230, a power distribution device 250, and an electric generator (first rotary electric machine) 270.

The engine 210, which is preferably a two-cylinder engine, is disposed below the trunk space 105 (see FIG. 1) of the scooter-type motorcycle 100. The engine 210 has two cylinders 212 parallel to and symmetric with respect to a vehicle central axis A as viewed in a plan view, and a crankshaft 211 extending generally parallel to the vehicle width direction (e.g., generally transverse to the vehicle central axis A). Though the engine 210 has two cylinders in the illustrated embodiment, the engine 210 can have more or fewer than two cylinders in other embodiments.

The pistons 215 in the cylinders 212 are connected to the crankshaft 211 via connecting rods 216. The crankshaft 211 is rotated via the vertical motion of the pistons 215. That is, vertical motion of the pistons 215 rotates the crankshaft 211, which drives the engine 210.

The crankshaft 211 has a crank gear 218 for transmitting power to the power distribution device 250. The crank gear 218 is disposed between large ends of the connecting rods 216 coupled to the two pistons 215.

The crank gear 218 is in meshing engagement with an intermediate gear 220, which is preferably rotatable about a shaft parallel to the crankshaft 211, and the intermediate gear 220 is in meshing engagement with a gear 252a formed on an outer periphery of a planetary carrier 252 of the power distribution device 250.

Since the crankshaft 211 is coupled to the power distribution device 250 via the intermediate gear 220, the torque of the crankshaft 211 is transmitted to the power distribution device 250 and the driving force from the power distribution device 250 is transmitted to the crankshaft 211.

The power distribution device 250 is located on a shaft preferably disposed generally parallel to the crankshaft 211 together with the motor 230 and the electric generator 270, and is rotatable about the shaft. Specifically, the power distribution device 250 is disposed on a power shaft 280 formed by extending the shaft part of a rotor 271 of the electric generator 270 in its axial direction, and is rotatable about the power shaft 280. The motor 230 and the electric generator 270 are also rotatable about the axis of the power shaft 280.

The power distribution device 250 splits the driving force transmitted from the engine 210 into a vehicle driving force to be transmitted to an axle 110 to drive a rear wheel 107 directly and an electricity generation driving force for causing the electric generator 270 to generate electricity.

As shown in FIG. 2, the power distribution device 250 is disposed between the motor 230 and the electric generator 270 on the power shaft 280.

In the power distribution device 250, the planetary carrier 252, which is preferably in meshing engagement with the intermediate gear 220 via the gear 252a on the outer periphery of the planetary carrier 252, is located axially adjacent to a sun gear 254 formed on an outer periphery of the power shaft 280. The planetary carrier 252 is rotatable coaxially with the sun gear 254 about the power shaft 280.

The planetary carrier 252 has planetary pins 252b extending generally parallel to the power shaft 280 and arranged, for example, on a circle about the axis of the power shaft 280. Planet gears 256 are rotatably mounted on the planetary pins 252b.

The planet gears 256 are preferably in meshing engagement with the sun gear 254 and revolve around the sun gear 254 while rotating on their own axes. The sun gear 254 is formed integrally with the shaft part of the rotor 271 of the electric generator 270 and constitutes a part of the power shaft 280.

A ring gear 258 is disposed around the planet gears 256 with its inner peripheral surface in meshing engagement with outer peripheries of the planet gears 256.

Since the ring gear 258 is combined with a rotor 231 of the motor 230, when the ring gear 258 rotates about the axis of the power shaft 280, the rotor 231 also rotates about the same axis. The motor 230 produces driving force by the rotation of the rotor 231.

In the power distribution device 250, when the planetary carrier 252 is rotated by the driving force from the crankshaft 211, the planetary pins 252b provided integrally with the planetary carrier 252 rotate about the axis of the power shaft 280. Then, the planet gears 256 rotate in the same way and revolve around the sun gear 254. Since the sun gear 254 and the ring gear 258 are in meshing engagement with the planet gears 256, they both rotate.

Since the sun gear 254 is formed on the power shaft 280 and formed integrally with the shaft part of the rotor 271 of the electric generator 270, when the sun gear 254 rotates, the rotor 271 also rotates. Thus, the torque of the sun gear 254 functions as an electricity generation driving force to cause the electric generator 270 to generate electricity.

The electric generator 270 generates electricity by rotation of the rotor 271 rotatably disposed in a stator 272 and constituting the power shaft 280, and supplies the generated electricity to a battery (see FIGS. 1 and 4) 400 and the motor 230. The electric generator 270 may have function as a motor (electric motor) driven by electricity supplied from a battery in addition to functioning as an electric generator. For example, the electric generator 270 may serve as a starter motor for starting-up the engine 210 when the charge amount of the battery is not more than a specific level. The battery 400 stores electricity supplied from the electric generator 270 and supplies electricity to the motor 230 and the electric generator 270.

The power shaft 280 extends from one side (right side) of the vehicle through the electric generator 270 and the power distribution device 250 and is rotatably inserted into the motor 230 on the other side (left side) of the vehicle.

The rotary axis of the motor 230 is coaxial with the power shaft 280, and the motor 230 is located in front of the rear wheel 107 in alignment with the electric generator 270, with the power distribution device 250 therebetween. The rotor 231 is disposed in a stator 233 for rotation about the axis of the power shaft 280, and is formed in a cylindrical shape to receive the power shaft 280 for rotation.

The motor 230 preferably functions as an electric generator in addition to functioning as an electric motor power source to drive the vehicle. The motor 230 may also serve as a starter motor for starting up the engine 210 when the charge amount of the battery is not more than a specific level. In one embodiment, the motor 230 functions as a regenerative motor for producing resistance to restrain the rotation of the axle 110 in the traveling direction during deceleration and braking.

In the motor 230, the rotor 231 is joined to one end 284a of a cylindrical body 282 of a sprocket 284 located on the other side (left side) of the vehicle and rotatable about the axis of the power shaft 280. The other end (the end on the other side of the vehicle) of the cylindrical body 282 of the sprocket 284 is supported by a bearing 284b.

The torque of the power shaft 280 is transmitted to the sprocket 284 via the sun gear 254, the planet gears 256, the ring gear 258 and the rotor 231. Then, the torque is transmitted from the sprocket 284 via a chain 287 entrained around the sprocket 284, a speed reduction gear section 286, a chain 289 and a sprocket 112 on the axle 110 at a rear part of the vehicle to the axle 110 to drive the rear wheel 107. The sprocket 284, the chain 287, the speed reduction gear section 286, the chain 289 and the sprocket 112 are housed in a cantilever rear arm part 202 of the drive unit 200.

The engine 210, the motor 230 and the electric generator 270 are coupled to each other via the planetary carrier 252, the ring gear 258 and the sun gear 254 in the power distribution device 250 having a planetary gear mechanism as described above. In the power distribution device 250, when the rotational speeds of two of the planetary carrier 252, the ring gear 258 and the sun gear 254 are determined, the rotational speed of the remaining one is indirectly determined.

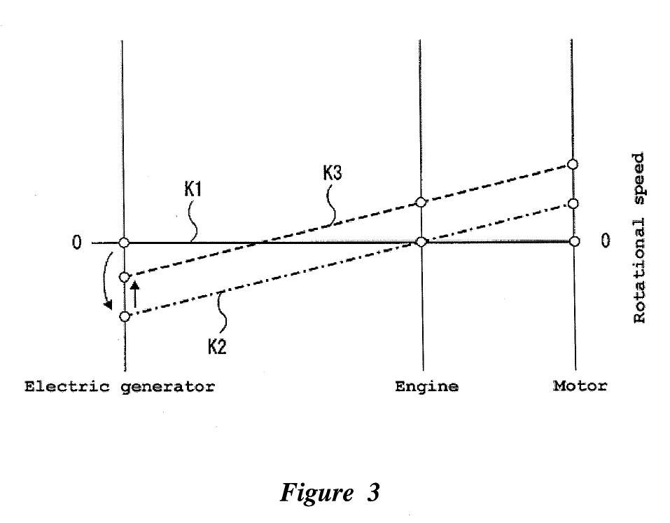

FIG. 3 is a collinear chart of the operation of the electric generator 270, the engine 210 and the motor 230 in the control device 300 for a hybrid vehicle. As shown in FIG. 3, in the power distribution device 250, the respective gear rotational speeds can be connected by a straight line in the collinear chart with the vertical axis representing rotational speed. In FIG. 3, a collinear line K1 indicates the state where the vehicle and the engine are both stopped, a collinear line K2 indicates the state where the engine 210 speed is zero and the vehicle is being driven by the motor 230 powered by electricity supplied from the battery 400, and a collinear line K3 indicates the state where the vehicle is being driven by both the engine 210 and the motor 230.

Therefore, when the rotational speeds of two of the electric generator 270 (rotor 271), the motor 230 (rotor 231) and the engine 210 are determined, the rotational speed of the remaining one is indirectly determined. That is, the rotational speed of the engine 210 is indirectly determined by determining the rotational speeds of the electric generator 270 and the motor 230. Since the rotational speed of the rotor 231 of the motor 230 is synchronized with the rotational speed of the rear driving wheel 107, that is, the traveling speed of the vehicle, the rotational speed of the engine 210 is determined by controlling the rotational speed of the electric generator 270.

In the scooter-type motorcycle 100 having the drive unit 200 as described above, the rear wheel 107 is rotated by at least one of the engine 210 and the motor 230 via the power distribution device 250. The operation of the engine 210 and the motor 230, that is, the operation of the drive unit 200, is determined based on the running condition of the scooter-type motorcycle 100 and the charge amount of the battery 400 (see FIGS. 1 and 4) for storing electricity for driving the motor 230.

In the scooter-type motorcycle 100 having the drive unit 200 constituted as described above, the control device 300 (see FIG. 4), which includes a control unit 330 (see FIG. 1) controls driving force.

FIG. 4 is a block diagram illustrating the general construction of the control device 300 for a hybrid vehicle according to one embodiment. In FIG. 4, the lines connecting the power distribution device 250, the engine 210, the motor 230 and the electric generator 270 are power transmission lines representing mechanically transmitted power.

The control device 300 shown in FIG. 4 includes, in addition to the control unit 330, an accelerator opening detection section 301, a vehicle speed detection section 302, a brake detection section 303, an engine speed sensor 304, a motor speed sensor 305, an electric generator speed sensor 306, a remaining battery level sensor 307, a motor current sensor 308, an electric generator current sensor 309, a battery current sensor 310, a throttle opening sensor 311, and so on.

The accelerator opening detection section 301 detects the accelerator opening variable by operation of an accelerator by the vehicle operator of the scooter-type motorcycle 100 and outputs it as accelerator opening information to the control unit 330. The vehicle speed detection section 302 detects the vehicle speed and outputs it as vehicle speed information to the control unit 330. The brake detection section 303 detects the degree of operation of a brake lever by the vehicle operator and outputs it as brake information to the control unit 330.

The speed sensors 304, 305 and 306 respectively detect the rotational speeds of the engine 210, the motor 230 and the electric generator 270 and output them as engine speed information, motor speed information and electric generator speed information, respectively, to the control unit 330.

The remaining battery level sensor 307 detects the state of charge (SOC), that is, the remaining battery level, of the battery 400 and outputs it as remaining battery level information to the control unit 330.

The motor current sensor 308 detects the current flowing into and out of the motor 230 and outputs it as motor input-output current information (hereinafter referred to as “motor current information”) to the control unit 330.

The electric generator current sensor 309 detects the current flowing into and out of the electric generator 270 and outputs it as electric generator input-output current information (hereinafter referred to as “electric generator current information”) to the control unit 330.

The battery current sensor 310 detects the current flowing into and out of the battery 400 and outputs it as battery input-output current information (hereinafter referred to as “battery current information”) to the control unit 330.

The throttle opening sensor 311 detects the throttle opening, specifically the valve opening of a throttle valve 223, of the engine 210 and outputs it as throttle opening information to the control unit 330.

Based on the information input from the detection sections 301 to 303 and the sensors 304 to 311, the control unit 330 controls the driving of the engine 210, the motor 230, the electric generator 270 and the battery 400 to control the operation of the vehicle.

The control unit 330 includes a hybrid control unit (hereinafter referred to as “HCU”) 332 as a main control section for controlling the operation of the vehicle, an electricity control section 350 for controlling the inputs to and outputs from the motor 230, the electric generator 270 and the battery 400, and an engine control section 338.

The HCU 332 receives the accelerator opening information from the accelerator opening detection section 301, the vehicle speed information from the vehicle speed detection section 302, and the brake information from the brake detection section 303. The HCU 332 also receives the engine speed information, the motor speed information and the electric generator speed information from the speed sensors 304 to 306, respectively, and the remaining battery level information from the remaining battery level sensor 307. The HCU 332 further receives the motor current information, the electric generator current information and the battery current information from the current sensors 308 to 310, respectively, and the throttle opening information from the throttle opening sensor 311.

Based on the input information, the HCU 332 outputs a drive command to the electricity control section 350 and the engine control section 338 to control the operation of the vehicle 100 in response to vehicle operator commands. For example, the HCU 332 outputs a drive command to the electricity control section 350 and the engine control section 338 based on the accelerator opening information so that torque proportional to the accelerator opening can be applied to the rear wheel.

In other words, the HCU 332 determines the operating state of the vehicle, including a stationary state, based on the input accelerator opening information, vehicle speed information, brake information, speed information, current information, remaining battery level information on the battery 400 and throttle opening information, and controls the operation of the vehicle based on the determined operating state of the vehicle.

Based on the input information, the HCU 332 determines whether to stop the engine 210 and drive the vehicle solely via the motor 230, or to start the engine 210 and drive the vehicle using engine power. The HCU 332 starts the vehicle using the motor 230 unless the temperature is low or the remaining battery level is low.

When the vehicle is powered by the engine to run, the HCU 332 starts the engine 210 using the electric generator 270 and the motor 230, and at the same time, calculates the amount of energy required for the whole vehicle. Then, the HCU 332 calculates the most efficient operating condition for achieving production of the calculated amount of energy, sends a command to the engine control section 338, and controls the rotation of the electric generator 270 via the electricity control section 350 to achieve the engine speed corresponding to the operating condition.

The engine power is controlled by the HCU 332 based on the amount of power used to drive the vehicle directly and the amount of electricity used by the motor 230 to drive the vehicle, and depending on the charge state of the battery 400. The HCU 332 controls the operation of the vehicle using the engine 210, the motor 230 and the electric generator 270 such that the energy consumption of the whole vehicle is always the minimum possible, that is, the energy efficiency is always maximized.

Specifically, when the vehicle has started running at a slow pace (e.g., is accelerating slowly from the stationary state) or is running at a low to medium speed (e.g., running steadily at a medium speed or lower) and the engine efficiency is low, the HCU 332 stops the engine 210 and drives the vehicle solely using the motor 230.

That is, when it is determined from the input accelerator opening information, vehicle speed information and brake information that the vehicle has started running at a slow pace or is running at a low to medium speed, the HCU 332 outputs an engine stop command to the engine control section 338 and a motor drive command to the electricity control section 350.

At this time, the motor drive command output from the HCU 332 requires the driving force to be produced by the motor 230 to correspond to the accelerator opening information. On receiving the motor drive command, the electricity control section 350 drives the motor 230 to rotate the rear wheel 107.

When the vehicle is running steadily, the HCU 332 drives the engine 210 to rotate the rear wheel 107 directly, and causes the engine 210 to drive the electric generator 270 so that the generated electricity can drive the motor 230 to rotate the rear wheel 107. That is, when it is determined from the input accelerator opening information, vehicle speed information and brake information that the vehicle is running steadily, the HCU 332 outputs a drive command to the engine control section 338 to drive the engine 210 and drives the motor 230 and the electric generator 270 via the electricity control section 350.

At this time, the engine power is split by the power distribution device 250 into two paths. The engine power through one path drives the electric generator 270, and the generated electricity drives the motor 230 to rotate the rear wheel 107. The engine power through the other path is transmitted to the axle 110 to rotate the rear wheel 107.

When the vehicle is running steadily and the driving force from the engine is transmitted through the two paths as described above, the HCU 332 controls the ratio of the engine powers transmitted through the two paths such that the efficiency of energy consumed by the whole vehicle can be maximized.

That is, when the engine 210 is operating, the HCU 332 controls the electricity generation output of the electric generator 270 such that the engine speed detected by the speed sensor 304 will not vary abruptly or greatly. In other words, the HCU 332 controls the electricity generation output of the electric generator 270 such that the emission and fuel consumption of the engine is small compared to conventional internal combustion engine vehicles. At the same time, the HCU 332 controls the electricity generation output of the electric generator 270, i.e. the engine speed, such that the remaining battery level of the battery 400 is always kept in a specific range, in other words, such that the driving of the motor 230 only causes variations of the remaining battery level of the battery 400 within a specific range.

When the vehicle is accelerating rapidly, the HCU 332 supplies, in addition to the driving force from the engine, electricity from the battery 400 to the motor 230, which transmits a drive force to drive the rear wheel 107.

That is, when it is determined from the input accelerator opening information, vehicle speed information and brake information that the vehicle is accelerating rapidly, the HCU 332 outputs an engine drive command to the engine control section 338 and a command to drive the motor 230 and the electric generator 270 to the electricity control section 350.

The HCU 332 also outputs a control command to supply electricity from the battery 400 to the motor 230, to the engine control section 338 and to the electricity control section 350.

In this way, when the vehicle is accelerating rapidly, the axle 110 is driven to rotate by the engine power transmitted via the power shaft 280 (see FIG. 2) and the driving force from the motor driven by the electricity supplied from the battery 400. Thus, the vehicle exhibits responsive and smooth motive performance and improved acceleration performance.

When the vehicle is decelerating or braking, the HCU 332 causes the rear wheel 107 to drive the motor 230. That is, when it is determined from the input information, in particular the brake information, that the vehicle is decelerating or braking, the HCU 332 outputs a motor regeneration command to the electricity control section 350 to cause the motor 230 to function as an electric generator so that the brake energy of the vehicle can be converted into more electricity.

That is, the HCU 332 can cause the motor 230 to function as a regenerative brake according to the brake information. The HCU 332 converts the regeneration output from the motor 230 from AC to DC using the electricity control section 350 and supplies the electricity collected by the motor 230 to the battery 400.

The HCU 332 performs control such that the battery 400 keeps a certain charge state, that is, such that variations in the remaining battery level of the battery 400 are small. When the charge amount of the battery 400 has become small, the HCU 332 starts charging the battery 400 by starting up the engine 210 and driving the electric generator 270. The HCU 332 controls the operation of the vehicle based on the remaining battery level information input from the remaining battery level sensor 307, in addition to the input accelerator opening information, vehicle speed information and brake information.

For example, when the battery 400 alone cannot afford to supply sufficient electricity to the motor 230, or when the input information indicates that the remaining battery level of the battery 400 has reached a specific level or lower, the HCU 332 starts the engine 210 via the engine control section 338. That is, the HCU 332 starts the engine 210 by sending a start signal to an ignition 222 via the engine control section 338 to charge the battery 400.

When the electricity supplied from the electric generator 270 to the battery 400 is more than a specific amount, the HCU 332 controls the output of the engine 210 via the engine control section 338 to reduce the electricity generated by the electric generator 270. Alternatively, the HCU 332 may stop driving the electric generator 270 to stop the supply of electricity to the battery 400, or may supply the electricity from the electric generator 270 to the motor 230, instead of the battery.

When the vehicle is stationary, the HCU 332 stops the engine 210 automatically. That is, when it is determined from the input accelerator opening information, vehicle speed information and brake information that the vehicle is stationary, the HCU 332 outputs an engine drive stop command to the engine control section 338 to stop the engine.

The electricity control section 350 controls the current path based on motor drive information, including the motor current information input from the HCU 332, and controls the driving of the motor 230. The motor 230 includes an inverter 230a. The inverter 230a converts the discharge output of the battery 400 input to the motor 230 via the electricity control section 350 from DC to AC, and converts the regeneration output of the motor 230 from AC to DC to output it to the electricity control section 350.

The electricity control section 350 also controls the current path based on electric generator drive information, including the rotational speed information of the electric generator 270 input from the HCU 332, and controls the driving and stopping of the electric generator 270. The electric generator 270 includes an inverter 270a.

The inverter 270a converts the generation output of the electric generator 270 from AC to DC to output it to the electricity control section 350, and converts the current input to the electric generator 270 from DC to AC.

Specifically, the electricity control section 350 supplies the discharge current from the battery 400 to the motor 230 and supplies the electricity generated by the electric generator 270 to the battery 400 and the motor 230 based on the output signal from the HCU 332. In addition, based on the output signal from the HCU 332, the electricity control section 350 supplies the regeneration output of the motor 230 to the battery.

The output signal from the HCU 332 to be input to the electricity control section 350 is based on the information input from the detection sections 301 to 303 and the sensors 304 to 311 to the HCU 332.

Thus, the electricity control section 350 responds to accelerator and brake operations by the vehicle operator, and controls the operation with reference to the rotational speed of the motor 230 such that the output torque of the motor 230 is in accordance with the accelerator and brake operations.

The engine control section 338 controls the operation of the engine 210 based on engine drive information input from the HCU 332, including the engine drive command, the engine stop command, and a throttle valve opening command, an engine ignition operation command, etc. issued when the engine is being driven.

Specifically, the engine control section 338 controls the operation of the ignition (indicated as “IGN.” in FIG. 4) 222, the throttle valve (indicated as “THB.” in FIG. 4) 223, an injector (indicated as “INJ.” in FIG. 4) 224, and a decompression device (indicated as “DECOMP.” in FIG. 4) 225.

The engine control section 338 can drive the rear wheel 107 to rotate, both by driving the engine 210 directly and by driving the motor 230 via the power distribution device 250 and the electric generator 270. The engine control section 338 can also control the driving of the engine 210 to supply electricity generated by the electric generator 270 to the battery 400.

The ignition 222, the throttle valve 223 and the injector 224 operate respectively in response to an ignition command, a throttle opening command, a fuel supply command, etc. input via the engine control section 338.

The decompression device 225 is actuated by an electronically controlled component which does not use engine hydraulic pressure, such as an electronic solenoid valve. The decompression device 225 is turned on based on the information input from the engine control section 338 to reduce the in-cylinder pressure when the engine is on the compression stroke. That is, the decompression device 225 opens an exhaust valve of the engine 210 to reduce the in-cylinder pressure during the compression stroke. Since the decompression device 225 is controlled electronically, the decompression device 225 can quickly respond to the input information to reduce the in-cylinder compression pressure, compared to the construction where hydraulic pressure is used.

The decompression device 225 is turned on based on the input information to reduce the in-cylinder compression pressure from the moment when the cranking of the engine is started. Since actuation of the decompression device 225 is controlled electronically such as by an electronic solenoid valve openable by magnetic force generated by energizing a coil and thus does not use engine hydraulic pressure as a drive medium, the decompression device 225 can be driven regardless of whether the engine 210 is operating or stationary.

The battery 400 is electrically connected via the electricity control section 350 to the electric generator 270 driven by the engine. The battery 400 supplies electricity to the motor 230 to drive it and stores electricity generated by the motor 230 and the electric generator 270.

In the control device 300, when the engine 210 is started up, the HCU 332 increases the rotational speed of the engine 210 until it exceeds a predetermined resonance point, while reducing the compression pressure in the cylinders 212 via the decompression device 225. When the engine speed has exceeded the resonance point and become proper for engine startup, the decompression device 225 is turned off and ignition is made to start up the engine 210.

The HCU 332 which operates as described above for engine startup is described in detail along with the control unit incorporating the HCU 332.

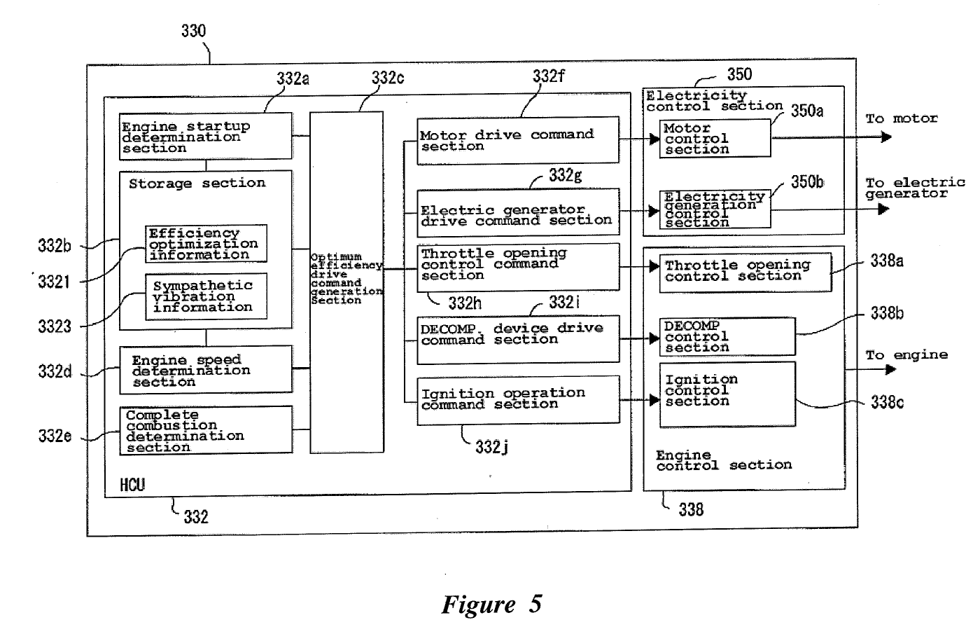

FIG. 5 is a functional block diagram of the control unit for explaining the functions of the HCU 332 related to engine startup.

As shown in FIG. 5, the HCU 332 includes an engine startup determination section 332a, a storage section 332b, an efficiency optimization drive command generation section (hereinafter referred to as “command generation section”) 332c, an engine speed determination section 332d, a complete combustion determination section 332e, and various command sections 332f to 332j.

The engine startup determination section 332a determines whether or not to start up the engine 210 based on the vehicle speed information input from the vehicle speed detection section 302 (see FIG. 4), the accelerator opening information input from the accelerator opening detection section 301 (see FIG. 4), and efficiency optimization information 3321 stored in the storage section 332b.

Since torque proportional to the accelerator opening is applied to the rear wheel 107, the accelerator opening information used in the determination can be replaced by rear wheel propulsion force in the efficiency optimization information 3321.

That is, the HCU 332 determines whether or not to start up the engine in order for the actual running state of the vehicle to achieve optimum energy efficiency. Even when the energy efficiency is low, when the remaining battery level of the battery 400 input from the remaining battery level sensor 307 is lower than a specific value, the engine startup determination section 332a determines to start up the engine 210.

The storage section 332b stores parameters used to drive the hybrid vehicle, specifically the drive unit 200, by the HCU 332. Here, in particular, parameters used in the engine startup process are described.

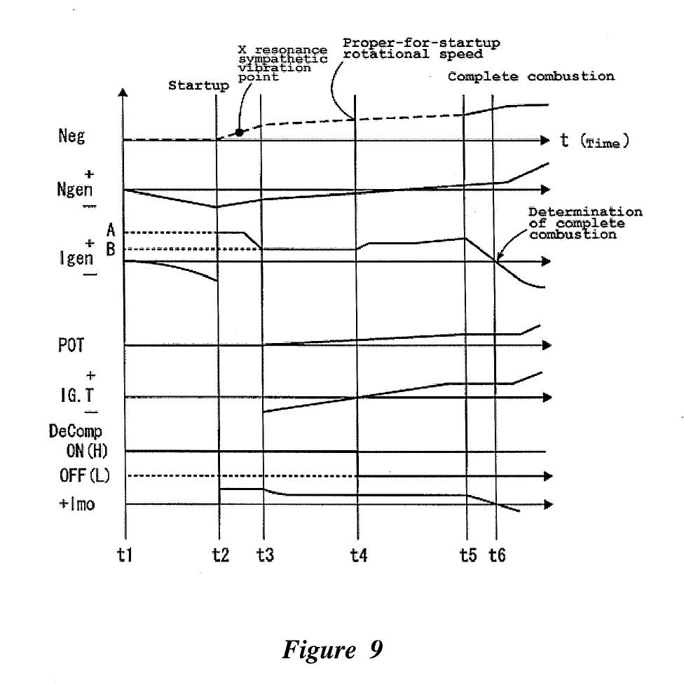

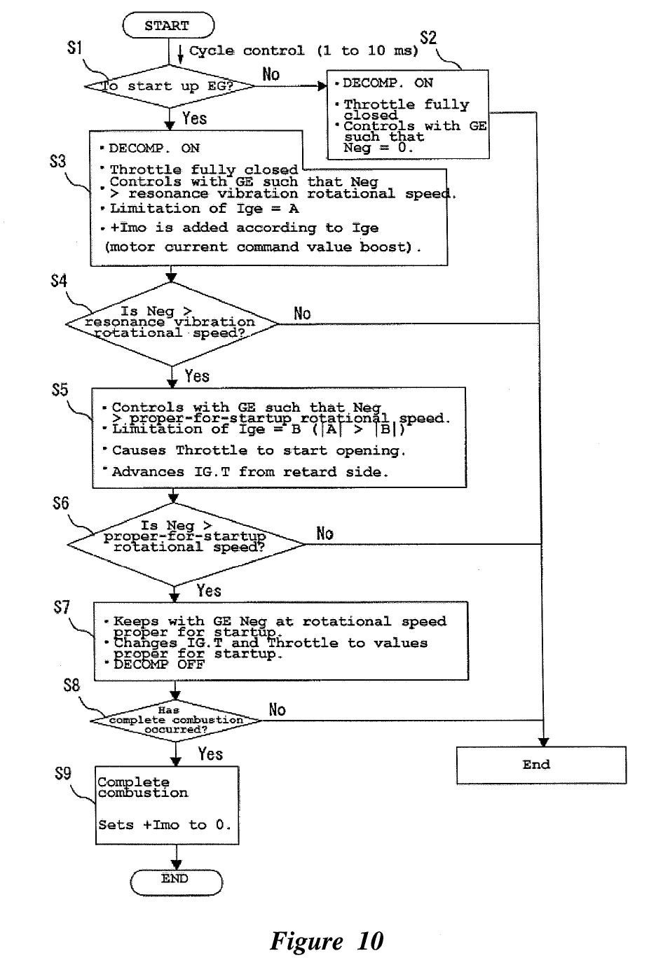

The storage section 332b stores, for example, specific limits A and B (see FIGS. 9 and 10) for electric generator current “Igen” used for engine startup, the efficiency optimization information 3321, resonance information 3323, and optimum-for-engine-startup rotational speed information based on the resonance rotational speed in the resonance information. The optimum-for-engine-startup rotational speed information is hereinafter referred to as “proper-for-startup rotational speed.”

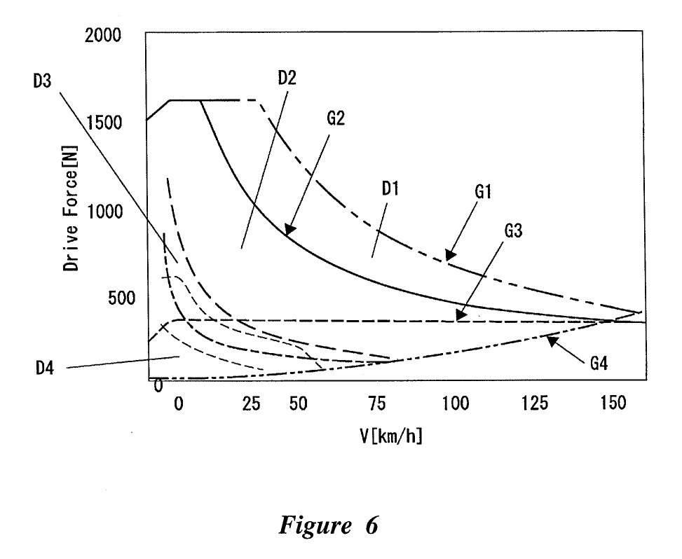

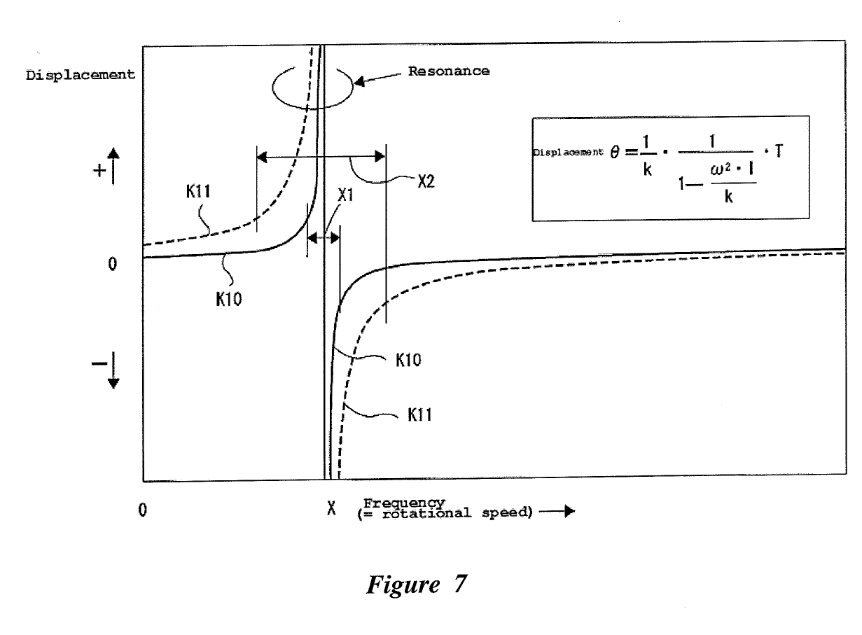

FIG. 6 is a diagram illustrating an example of the efficiency optimization information 3321, and FIG. 7 is a diagram illustrating an example of the resonance information 3323.

The efficiency optimization information 3321 shown in FIG. 6 is in the form of a map showing operating conditions where energy use efficiency is most preferable in the scooter-type motorcycle 100 incorporating the hybrid driving device 300.

FIG. 6 shows the relationship between the rear wheel propulsion force and the vehicle speed, wherein graphs G1 to G4 represent driving forces achieved by the components in various combinations. Specifically, the graph G1 represents driving force achieved by the motor at maximum output plus the engine driven directly, and the graph G2 represents driving force achieved by the motor driven by electricity generated by the electric generator plus the engine driven directly. The graph G3 represents driving force achieved by the engine driven directly, and the graph G4 represents running resistance.

FIG. 6 also shows the control states of the battery 400 (see FIG. 4), the engine 210, the motor 230 and the electric generator 270 where optimum energy efficiency in accordance with operating conditions can be achieved in the scooter-type motorcycle 100. The operating conditions corresponding to the control states of the battery 400 (see FIG. 4), the engine 210, the motor 230 and the electric generator 270 where optimum energy efficiency can be achieved are represented as regions D1 to D4.

The operating condition of the region D1 indicates the state where the battery 400 is discharged (SOC−), and the operating condition of the region D2 indicates that the highest energy efficiency can be achieved when the battery is neither charged nor discharged. The operating condition of the region D3 indicates that the highest energy efficiency can be achieved when the battery is charged (SOC+), and the operating condition of the region D4 indicates that the highest energy efficiency can be achieved when the engine is stationary and the battery electricity is used for driving (SOC−).

In the region D1, the load imposed on the drive unit 200 ranges approximately from 100% to the maximum of the engine output, and the engine output is kept at 100% while the battery output is varied as necessary.

In the region D2, the load imposed on the drive unit 200 ranges approximately from 35% to 100% of the engine output, and the engine output is adjusted by varying the electric generator speed (here, equivalent to “engine speed”) at full throttle. In the region D2, at the same time, the battery output is controlled by sluggishly charging and discharging the battery within SOC management width to increase the overall energy efficiency, though in perspective SOC±0.

In the region D3, the load imposed on the drive unit 200 ranges approximately from 23% to 35% of the engine output, and the engine output is controlled by adjusting the electric generator speed and the throttle opening. The fuel consumption rate in the region D3 is at most about 150% of the net fuel consumption rate at the lowest electric generator (engine) speed and at half the opening.

In the region D4, the load imposed on the drive unit 200 ranges approximately from 0% to 23% of the engine output, and the engine is stopped. In order to avoid frequent startup and stopping of the engine, a hysteresis is provided for engine output control. For the battery output control in the region D4, the vehicle runs only on the battery output, and the battery output efficiency is equivalent to about 150% of the net fuel consumption rate of the engine.

The resonance information 3323 shown in FIG. 7 represents vibration caused in the vehicle when starting up the engine. The displacement shown in FIG. 7 indicates the inclination (amplitude) with which the engine oscillates with respect to the vehicle body. In the drawing, a graph K10 represents the amplitude of the engine 210 incorporating the drive unit 200 in this embodiment, and a graph K11 represents the amplitude of conventional motorcycle and general-purpose engines and those incorporating a gas heat pump.

In the conventional engines represented by the graph K11, patterns of a specific size are formed in the flywheel to suppress variations in the rotational speed while idling and to facilitate starting the vehicle running. In contrast, idling is not necessary for the scooter-type motorcycle 100 of this embodiment having the engine 210 represented by the graph K10. In the scooter-type motorcycle 100, the patterns in the flywheel can be made small compared to the conventional engines. In addition, vibration caused when starting up and stopping the engine can be lessened to reduce the gyro effect of the engine.

Based on the resonance information, a resonance point (resonance rotational speed) X is set according to various parts constituting the drive unit 200, which is made up of plural parts, and the running condition. In this embodiment, the resonance point (resonance rotational speed) is set outside the region where the driving force of the engine 210 can be used substantially, specifically in the initial stage of engine startup. As shown in FIG. 7, a rotational speed range X1 where resonance occurs in the drive unit 200 of this embodiment is narrow compared to a rotational speed range X2 for drive units of conventional motorcycle and general-purpose engines and those incorporating a gas heat pump.

Based on the set resonance point X, a proper-for-startup rotational speed which is proper to start up the engine 210 is set. The proper-for-startup rotational speed is higher than the resonance rotational speed X. The proper-for-startup rotational speed is not influenced by the resonance rotational speed X when starting up the engine 210, and the engine 210 can be started at the proper-for-startup rotational speed. That is, the crankshaft 211 (see FIG. 2) receives a least load at the proper-for-startup rotational speed, even when combustion occurs in the engine 210.

The command generation section 332c generates command information for driving the drive unit 200 itself based on the various information input to the HCU 332, the information stored in the storage section 332b, and the determination information from the engine startup determination section 332a, the engine speed determination section 332d and the complete combustion determination section 332e. That is, the command generation section 332c generates and outputs a command to drive the engine 210, the motor 230 and the electric generator 270 such that the vehicle can be driven with the highest energy efficiency (optimum state).

Specifically, the command generation section 332c generates drive command information for creating a vehicle operating condition with optimum energy efficiency based on the vehicle speed information from the vehicle speed detection section 302 (see FIG. 4), the rear wheel propulsion force (driving force) based on the accelerator opening information from the accelerator opening detection section 301 (see FIG. 4), and the efficiency optimization information 3321 stored in the storage section 332b, and outputs the generated drive command information to various command sections 332f to 332j. The drive command information is output via the various command sections 332f to 332j to the electricity control section 350 and the engine control section 338 as drive information.

Specifically, the drive command information includes information such as on the motor current for controlling the driving of the motor 230, the electric generator speed and current for controlling the electric generator 270, the throttle opening for controlling the engine 210, the driving (on and off) of the decompression device, the ignition operation, etc.

The command generation section 332c reads the resonance rotational speed X (see FIG. 7) where resonance occurs in the drive unit 200 from the resonance information 3323 in the storage section 332b, and generates an electric generator speed command specifying an engine speed higher than the resonance rotational speed X.

The engine speed is determined by the electric generator speed and the rotational speed of the motor rotating in response to rotation of the rear wheel, because of the constitution of the drive unit 200 (see FIG. 2) having the power distribution device 250 (see FIG. 2). Thus, the command generation section 332c can vary the engine speed by outputting a command to vary the electric generator speed.

The command generation section 332c also reads specific limits A and B (|A|>|B|) for electric generator current “Igen” from the storage section 332b, and generates drive command information for controlling the electric generator 270 so as to achieve electric generator current in accordance with the limits.

Further, in order to control the motor, the command generation section 332c generates motor current control command information for controlling the motor current and motor torque control command information.

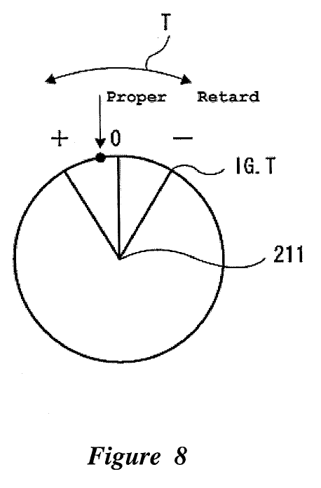

In addition, the command generation section 332c generates a command to control the engine ignition operation performed by the ignition (see FIG. 4) 222 at specific timing. For example, the command to control the ignition operation (ignition operation command) advances the ignition timing from the retard side. FIG. 8 is a diagram illustrating the rotational angle of the crankshaft 211 indicating ignition timing.

In particular, when controlling engine startup, the command generation section 332c generates various control command information such as on the driving of the decompression device, throttle opening operation, electric generator speed, limitation of the electric generator current to the A value, motor current, etc., based on the vehicle speed, the rear wheel propulsion force and the efficiency optimization information 3321.

The engine speed determination section 332d compares the input engine speed and the resonance rotational speed X read from the resonance information 3323 in the storage section 332b, and outputs the comparison result to the command generation section 332c. The engine speed determination section 332d also compares the input engine speed and the proper-for-startup rotational speed read from the storage section 332b, and outputs the comparison result to the command generation section 332c.

The complete combustion determination section 332e determines whether or not complete combustion has occurred in the engine 210, and outputs the determination result to the command generation section 332c. That is, the complete combustion determination section 332e determines whether or not fuel is combusted in the combustion chamber via the ignition 222 (see FIG. 4) in the engine 210 and the engine 210 has started driving completely, and outputs the determination result to the command generation section 332c. The complete combustion determination section 332e monitors the electric generator current, and determines that complete combustion has occurred in the engine if a current flowing in the direction of electricity generation is detected.

The motor drive command section 332f outputs a command related to motor drive control, for example a motor current control command, among the drive commands generated by the command generation section 332c, to the electricity control section 350 as motor drive information.

The electric generator drive command section 332g outputs a command related to electric generator drive control, for example an electric generator speed control command and an electric generator current control command, among the drive commands generated by the command generation section 332c, to the electricity control section 350 as electric generator drive information.

The throttle opening control command section 332h outputs a control command related to throttle opening, among the commands related to engine drive control generated by the drive command generation section 332c, to the engine control section 338 as engine drive information.

The decompression device drive command section 332i outputs a control command related to the driving of the decompression device, among the commands related to engine drive control generated by the drive command generation section 332c, to the engine control section 338 as engine drive information.

The ignition operation command section 332j outputs a control command related to ignition operation, among the commands related to engine drive control generated by the drive command generation section 332c, to the engine control section 338 as engine drive information.

In the electricity control section 350, a motor control section 350a and an electric generator control section (“electricity generation control section” in the drawing) 350b respectively control the motor 230 and the electric generator 270 based on the output signal from the HCU 332, specifically the information input from the motor drive command section 332f and the electric generator drive command section 332g. That is, the motor control section 350a and the electric generator control section 350b supply the discharge current from the battery 400 to the motor 230 and supply the electricity generated by the electric generator 270 to the battery 400 and the motor 230 based on the input drive command information. In addition, the motor control section 350a and the electric generator control section 350b supply the regeneration output of the motor 230 to the battery based on the information input from the motor drive command section 332f and the electric generator drive command section 332g.

The engine control section 338 includes a throttle opening control section 338a for controlling the opening of the throttle valve 223, a decompression device control section 338b for controlling the driving of the decompression device 225, and an ignition control section (ignition operation control section) 338c for controlling the driving of the ignition 222 and the injector 224.

The control sections 338a to 338c control the throttle valve 223, the decompression device 225, and the ignition 222 and the injector 224 based on the drive information input from the HCU 332, specifically the drive command information from the command sections 332h to 332j, respectively.

The engine startup operation of the control device 300 as described above is described in detail with reference FIGS. 9 and 10.

FIG. 9 is a timing chart for explaining the engine startup control process by the control device 300 for a hybrid vehicle according to the present invention. In FIG. 9, “Neg” denotes engine speed, “Ngen” electric generator speed, “Igen” electric generator current, “POT” throttle opening, “IG.T” ignition timing, “DeComp” the decompression device, and “±Imo” motor drive current.

FIG. 10 is a flowchart for explaining the engine startup control process. On the graph of the engine speed “Neg” shown in FIG. 9, the dotted portion from t1 to t5 shows the rotational speed of the engine as being driven by the electric generator 270 used as a starter motor.

When the engine 210 is stationary (at t1 shown in FIG. 9), in step S1, the HCU 332 determines whether or not to start the engine 210 based on the input vehicle speed, rear wheel propulsion force, and efficiency optimization information for the whole system of the scooter-type motorcycle 100. Specifically, determination as to whether or not to start the engine 210 is made by the engine startup determination section 332a in the HCU 332. The process proceeds to step S2 if the engine is not to be started up in the determination of step S1, and to step S3 if the engine is to be started up.

The determination as to whether or not to start up the engine is made to achieve the highest efficiency for the whole system, and made regularly (1 to 10 ms) when the scooter-type motorcycle 100 incorporating the system is being driven. The operating states of the engine 210, the electric generator 270 and the motor 230 in step S1 are indicated, for example, by a collinear line between the collinear lines K1 and K2 in FIG. 3.

In step S2, the HCU 332 turns on the decompression device 225 to reduce the compression pressure inside the cylinder 212, closes the throttle valve fully, and controls “Neg” to 0 through the electric generator 270, to end the process. Specifically, in step S2, the command generation section 332c outputs a drive command to the decompression device drive command section 332i, the throttle opening control command section 332h and the electric generator drive command section 332g based on the determination result by the engine startup determination section 332a (to stop the engine). Upon receiving the drive command, the command sections 332i, 332h and 332g output a drive command to the engine control section 338 and the electricity control section 350 to control the driving of the decompression device 225, the throttle valve 223 and the electric generator 270.

After the engine startup process is ended, cycle control starts the process again from the engine startup determination step S1 at regular intervals of 1 to 10 ms.

In step S3, the HCU 332 turns on the decompression device 225 to reduce the compression pressure inside the cylinder 212, closes the throttle valve fully, and controls “Neg” so as to be higher than the resonance rotational speed through the electric generator 270. At this time, the current “Ige” to the electric generator 270 is limited to the limit A, and may be added with the current “±Imo” to the motor 230 depending on the current of the electric generator 270.

This is to suppress rotation of the motor 230 which occurs with the rotation of the electric generator 270, being driven as a starter (electric motor) to rotate the engine, due to the construction of the drive unit 200 having the power transmission device 250. In this way, direct transmission from the electric generator 270 to the engine 210 via the power transmission device 250 can be facilitated. In other words, the HCU 332 outputs a motor current command value boost to the electricity control section 350.

Specifically, in step S3, the command generation section 332c monitors the determination result by the engine startup determination section 332a (to start up the engine), and outputs a drive command to the command sections 332f to 332i. At this time, the command generation section 332c reads the resonance rotational speed X from the resonance information 3323 in the storage section 332b and the limit A which is an upper limit for the current of the electric generator 270, and generates control command information on rotational speed and current for the electric generator 270. Upon receiving the drive command, the command sections 332f to 332i output a drive command to the electricity control section 350 and the engine control section 338 to control the driving of the motor 230, the electric generator 270, the throttle valve 223 and the decompression device 225.

After step S3, the process proceeds to step S4. The process in step S3 is performed at timing t2 shown in FIG. 9. The operating states of the engine 210, the electric generator 270 and the motor 230 in step S3 are indicated, for example, by the collinear line K2 in FIG. 3.

In step S4, the HCU 332 determines whether or not the engine speed “Neg” is higher than the resonance rotational speed. Specifically, the determination in step S4 as to whether or not the engine speed “Neg” is higher than the resonance rotational speed is made by the engine speed determination section 332d in the HCU 332, and the determination result is output to the command generation section 332c so that the command generation section 332c can perform processing based on the determination.

The process proceeds to step S5 if the engine speed “Neg” is higher than the resonance rotational speed in step S4, and if not, the engine startup process is ended temporarily and returns to step S1 after a specific period of time.

In step S5, the HCU 332 performs control through the electric generator 270 such that the engine speed “Neg”>the rotational speed proper for startup (proper-for-startup rotational speed). At this time, the current “Ige” to the electric generator 270 is limited to the preset limit B (|A|>|B|). In addition, the HCU 332 starts opening the throttle valve and advances the ignition timing “IG.T” from the retard side (“−”side in FIG. 8).

Specifically, the command generation section 332c monitors the result of the comparison performed by the engine speed determination section 332d between the proper-for-startup rotational speed read from the storage section 332b and the input engine speed, and outputs a drive command to the command sections 332f to 332j. At this time, the command generation section 332c reads the limit B, which is an upper limit for the current of the electric generator 270 smaller than the limit A from the storage section 332b, and generates control command information on rotational speed and current for the electric generator 270.

The ignition timing “IG.T” shown in FIG. 8 is initially set to a position retarded (on the retard side) from the proper ignition timing (the position indicated as “Proper” in FIG. 8). This is to prevent a problem which would occur if the ignition timing was on the advance side, that the crankshaft could not rotate smoothly or continuously because of a sudden increase in the compression pressure inside the cylinder after ignition due to too early combustion.

In step S5, the throttle valve is gradually opened from a moment before the decompression device 225 is turned off until a throttle valve opening proper for startup is achieved, in view of the possibility that the fuel could be ignited when the operation of the decompression device 225 is turned off. The process in step S5 is performed from timing t3 shown in FIG. 9. The operating states of the engine 210, the electric generator 270 and the motor 230 in step S5 are indicated, for example, by the collinear line K3 shown in FIG. 3.

After the process in step S5, the process proceeds to step S6, where the HCU 332 determines whether or not the engine speed “Neg” is higher than the proper-for-startup rotational speed. Specifically, in step 6, the engine speed determination section 332d compares the input engine speed and the proper-for-startup rotational speed read from the storage section 332b, and outputs information as to whether or not the engine speed>the proper-for-startup rotational speed to the command generation section 332c.

If the engine speed “Neg” is higher than the proper-for-startup rotational speed in step S6, the process proceeds to step S7, and if not, the process is ended.

In step S7, the HCU 332 keeps the engine speed “Neg” at the rotational speed proper for startup through the electric generator 270, sets the ignition timing “IG.T” and the throttle opening “POT” to values proper for startup, and turns off the decompression device, to proceed to step S8.

Specifically, in step S7, the command generation section 332c monitors the determination result by the engine speed determination section 332d, and outputs a drive command to the command sections 332g, 332i, 332h and 332j. In this way, the rotational speed of the electric generator 270, the ignition timing and the throttle opening are respectively controlled to positions proper for engine startup and the pressure reducing operation by the decompression device 225 is stopped via the electricity control section 350 and the engine control section 338.

The process of keeping the engine speed “Neg” at the rotational speed proper for startup through the electric generator 270 in step S7 is to increase the torque of the motor 230 by an amount corresponding to engine pumping in order to keep up the engine speed “Neg.” The process in step S7 is performed at timing t4 shown in FIG. 9.

In step S8, the HCU 332 determines whether or not complete combustion has occurred in the engine. The determination of complete combustion in the engine in step S8 is made based on whether or not the electric generator current is flowing in the direction of electric generation by the electric generator, by the HCU 332, specifically the complete combustion determination section 332e, monitoring the electric generator current “Igen.” If complete combustion has occurred in the engine, that is, if the HCU 332 has detected the electric generator current “Igen” flowing in the direction of electricity generation by the electric generator, the process proceeds to step S9, and if not, that is, if no current is flowing through the electric generator, the process is ended.

In step S9, the HCU 332 sets the motor drive current “±Imo” to 0 after complete combustion in the engine to end the engine startup process. Specifically, in step S9, the command generation section 332c monitors the determination result by the complete combustion determination section 332e, and upon receiving information indicating that complete combustion has occurred, outputs a command to the motor drive command section 332f to set the current supplied to the motor to 0. After that, the command generation section 332c generates command information and outputs it to the command sections 332f to 332j so as to achieve operation with high energy efficiency based on the efficiency optimization information 3321, the input vehicle speed, accelerator opening, etc. The process in step S9 is performed at timing t6 shown in FIG. 9.

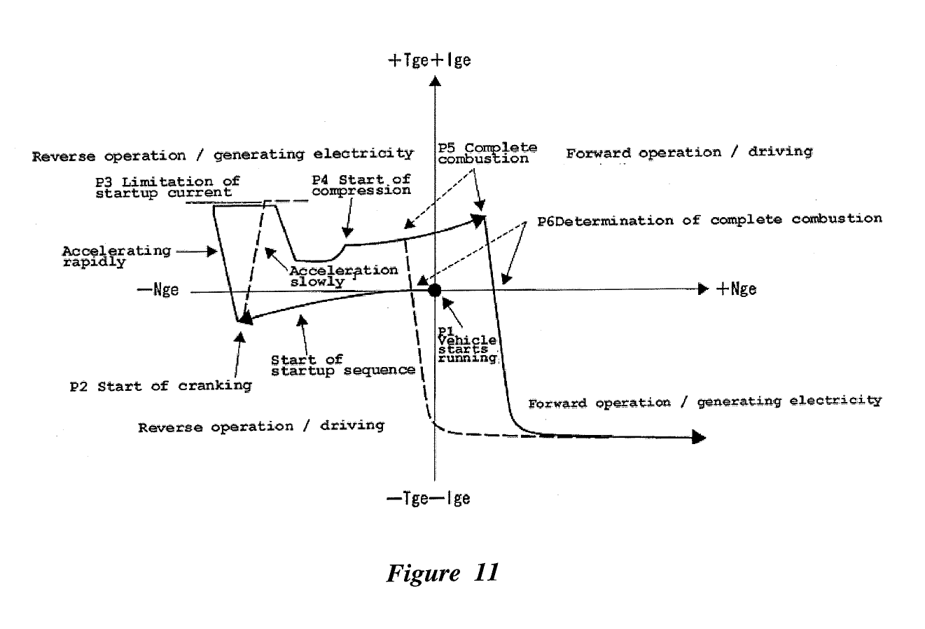

FIG. 11 is a diagram showing electric generator characteristics for explaining the process of starting up the engine from a vehicle stationary state performed by the driving device of this embodiment. FIG. 11 shows the relationship between the rotational speed and current of the electric generator in the engine startup process, with “Tge” and “Ige” in the vertical axis representing electric generator torque and current, respectively, and “Nge” representing electric generator speed. Two patterns of characteristics are shown in FIG. 11, in which the vehicle accelerates rapidly and slowly when it starts running.

As shown in FIG. 11, after the vehicle starts running (P1), the engine startup process starts. With the decompression device turned on and the throttle valve fully closed, the HCU 332 controls the electric generator speed so as to keep the engine speed at 0. At P2, cranking is started by starting the motor and the electric generator rotating. The electric generator is operated in reverse, and the engine startup process is started. The current to the electric generator is limited (to the limit “A” shown in FIG. 10) by startup current limitation at P3. When the engine speed exceeds the resonance rotational speed and reaches the proper-for-startup rotational speed, compression starts at P4, where the decompression device is turned off to start compression inside the cylinder.

Complete combustion occurs in the engine at P5, and the torque of the electric generator decreases. At this time, the torque of the electric generator turns from positive to negative. At the boundary point between positive and negative, the HCU 332 (specifically the complete combustion determination section 332e) determines complete combustion, after which the electric generator operates forward and generates electricity.

According to this embodiment, in the scooter-type motorcycle 100 having the power distribution device 250, when the engine is driven by the electric generator 270 and the motor 230, the decompression device 225 is driven to reduce the compression pressure inside the cylinder 212 from the moment when cranking of the engine 210 is started. In this way, in the scooter-type motorcycle 100, cranking torque of the crankshaft 211 of the engine 210 which changes abruptly before and after engine startup can be decreased. Thus, impact at engine startup can be reduced without increasing the capacity of the battery 400 for supplying a current to the motor 230, and increasing the size of the motor 230 itself to increase the torque produced by the motor.

That is, the device is mountable on a vehicle such as a motorcycle which has a limited mounting space compared to an automobile and thus cannot secure a space for a battery which becomes larger as its charging capacity increases. The device can lessen the impact at engine startup, or increase and decrease in propulsion force not intended by an operator, even when the rotary electric machine for running purpose being driven is outputting constant torque, thereby allowing the operator to perform proper operation.

In this embodiment, the HCU 332 generates a command to drive the motor 230, the electric generator 270 and the engine 210, and outputs the generated command to the electricity control section 350 and the engine control section 338, which should not be construed as a limitation. Alternatively, the electricity control section 350 and the engine control section 338 may have the function of the HCU 332, or other plural control devices may have the function of the HCU 332.

In accordance with one construction, a driving device for a hybrid vehicle is provided, which includes an engine for producing power and a first rotary electric machine for functioning at least as an electric generator. A power distribution device distributes the power produced by the engine to the first rotary electric machine and a driving wheel. A second rotary electric machine functions at least as an electric motor to produce power other than the power produced by the engine to drive the driving wheel. A storage battery supplies electricity to the first rotary electric machine and the second rotary electric machine. A pressure reduction device provided in the engine reduces a compression pressure inside a cylinder of the engine created while cranking the engine. A control device controls the first rotary electric machine and the second rotary electric machine to start up the engine, and to drive the pressure reduction device when starting up the engine to reduce the compression pressure inside the cylinder from a moment when the cranking of the engine is started.

With this construction of the hybrid vehicle having the power distribution device, when the engine is driven by the first rotary electric machine and the second rotary electric machine, the pressure reduction device is driven to reduce the compression pressure inside the cylinder from the moment when cranking of the engine is started. In this way, the cranking torque of the engine crankshaft, which changes abruptly before and after engine startup, can be decreased in the hybrid vehicle having the power transmission device. Thus, impact at engine startup can be reduced without increasing the capacity of the storage battery for supplying a current to the second rotary electric machine, and increasing the size of the motor because of an increase in the torque produced by the motor.

That is, the device is mountable on a vehicle, such as a motorcycle, which has a limited mounting space compared to an automobile and thus cannot secure a space for a battery which increases as its charging capacity increases. The device can lessen the impact at engine startup, or increase and decrease in propulsion force not intended by an operator, even when the rotary electric machine is outputting constant torque, thereby allowing the operator to properly operate the vehicle.

In accordance with another construction of a hybrid vehicle having a driving device, as discussed above, the control device controls a rotational speed of the engine via the power distribution device by controlling a rotational speed of the first rotary electric machine. The control device stops the pressure reducing operation of the pressure reduction device and ignites the engine after controlling the first rotary electric machine so as to make the engine speed higher than a predetermined resonance rotational speed of the engine.

With this construction, the engine speed is controlled via control of the rotational speed of the first rotary electric machine so as to make the engine speed higher than the resonance rotational speed of the engine. After the engine speed reaches a rotational speed which facilitates engine startup, the pressure reducing operation of the pressure reduction device is stopped and the engine is ignited. Thus, it is not necessary to control the engine itself in order to bring the engine speed to a rotational speed which facilitates engine startup, and the engine can be started up without impact by controlling only the first rotary electric machine and the pressure reduction device.

In accordance with another construction of a hybrid vehicle having a driving device, as discussed above, the power distribution device is a planetary gear train having a first rotary element coupled to the engine, a second rotary element coupled to the first rotary electric machine, and a third rotary element coupled to the second rotary electric machine and the driving wheel, which are mechanically coupled to each other to synthesize or distribute their power among themselves. The control device controls the engine speed via the first and second rotary elements by controlling a rotational speed of the first rotary electric machine when starting up the engine, and controls the second rotary electric machine when power is transmitted from the second rotary element to the first rotary element to prevent power transmission to the third rotary element.

With this construction, the engine speed is controlled via the first and the second rotary element of the power distribution device, which is a planetary gear train, by controlling the rotational speed of the first rotary electric machine. When power is transmitted from the second rotary element to the first rotary element, the second rotary electric machine is controlled so as to prevent power transmission to the third rotary element. Thus, by controlling the rotational speed of the first rotary electric machine, power to be transmitted from the first rotary electric machine to the engine via the power distribution device can be transmitted directly, not via the second rotary electric machine. In this way, the engine can be started up more efficiently by only controlling the first rotary electric machine.

In accordance with another construction of a hybrid vehicle having a driving device, as discussed above, the pressure reduction device operates using a power medium other than hydraulic pressure of the engine.

With this construction, the pressure reduction device operates using a power medium other than the engine hydraulic pressure, and thus can be driven independently, regardless of whether the engine is operating or stationary.

In accordance with another construction of a hybrid vehicle having a driving device, as discussed above, a vehicle speed detection section is provided for detecting a speed of the vehicle incorporating it to output the detected vehicle speed to the control device. An accelerator opening detection section detects an opening of an accelerator operated by an operator to output the detected accelerator opening to the control device. An engine speed detection section detects the engine speed to output it to the control device. The control device includes a startup determination section for determining whether or not to start up the engine according to a running condition of the vehicle based on the input vehicle speed and accelerator opening, an engine speed determination section for determining whether or not the input engine speed is higher than a predetermined resonance rotational speed, and whether or not the input engine speed is higher than a proper-for-startup rotational speed proper for engine startup. An engine control section performs engine control, including operation of the pressure reduction device, opening operation of a throttle valve of the engine, and operation of an ignition device for igniting the engine at specific timing. A first and a second rotary electric machine control section for respectively controlling the first and the second rotary electric machine. A drive command section uses the determination result by the startup determination section, the determination result by the engine speed determination section, and the various information input to the control device to output a drive command to the first and the second rotary electric machine control section and the engine control section based on an operating condition of the vehicle to drive them in parallel with each other. When the startup determination section determines to start up the engine, the drive command section outputs a drive command to cause the first rotary electric machine control section to control the rotational speed of the first rotary electric machine to cause the engine control section to reduce the pressure via the pressure reduction device and fully close the throttle valve of the engine from the moment when cranking of the engine is started. The drive command also causes the second rotary electric machine control section to control the second rotary electric machine so as to prevent power transmission from the second rotary element to the third rotary element until the engine speed determination section determines that the engine speed is higher than the resonance rotational speed. When the engine speed determination section determines that the engine speed is higher than the resonance rotational speed, the drive command section outputs a drive command to cause the engine control section to reduce the pressure through the pressure reduction device and gradually open the throttle valve, and to cause the first rotary electric machine control section to control the first rotary electric machine so as to make the engine speed higher than the proper-for-startup rotational speed, until the engine speed is determined to be higher than the proper-for-startup rotational speed. When the engine speed determination section determines that the engine speed is higher than the proper-for-startup rotational speed, the drive command section outputs a drive command to cause the engine control section to stop the pressure reducing operation of the pressure reduction device and ignite the engine, and stops the drive command output to the second rotary electric machine control section for preventing power transmission by the second rotary electric machine.

With this construction, in the hybrid vehicle having the power distribution device, engine startup can be completed in a short period of time and electricity can be supplied immediately from the first rotary electric machine to the second rotary electric machine. Thus, even in the case where a battery for supplying electricity to the second rotary electric machine is provided, power consumption of the battery can be suppressed, which allows the use of a battery with a smaller storage capacity.

In accordance with another construction of a hybrid vehicle having a driving device, as discussed above, a current consumed when the first rotary electric machine is being driven by the first rotary electric machine control section is larger when the engine speed is between 0 and the resonance rotational speed than when the engine speed is between the resonance rotational speed and the proper-for-startup rotational speed.

With this construction, the resonance rotational speed of the engine, which is a cause of the impact at engine startup, can be exceeded immediately. Thus, the operator of the vehicle incorporating the inventive driving device for a hybrid vehicle can operate the vehicle without sensing vibration due to the resonance rotational speed.

In accordance with another construction of a hybrid vehicle having an engine and a motor is provided in which a driving wheel is driven by at least one of the engine and the motor as a power source. The hybrid vehicle includes a control device for controlling operation of the motor and startup of the engine when the motor is being driven. A pressure reduction device is provided in the engine for reducing a compression pressure inside a cylinder of the engine created while cranking the engine, wherein the control device drives the pressure reduction device when starting up the engine to reduce the compression pressure inside the cylinder from a moment when the cranking of the engine is started.

With this construction, when controlling engine startup while the motor is being driven, the pressure reduction device is driven to reduce the compression pressure inside the cylinder from the moment when cranking of the engine is started. Thus, a cranking torque of the engine crankshaft, which changes abruptly before and after engine startup, can be decreased in the hybrid vehicle. Therefore, the device can lessen the impact at engine startup, or increase and decrease in propulsion force not intended by the operator, even when the rotary electric machine for running purpose being driven is outputting constant torque, thereby allowing the operator to perform proper operation.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims.

What is claimed is:

1. A hybrid vehicle comprising:
an internal combustion engine configured to produce power;
a first rotary electric machine configured to operate at least as an electric generator;
a power distribution device configured to distribute the power produced by the engine to at least one of the first rotary electric machine and a driving wheel;
a second rotary electric machine configured to operate at least as an electric motor, the second rotary electric machine producing power to drive the driving wheel;
a storage battery for supplying electricity to the first rotary electric machine and the second rotary electric machine;
a pressure reduction device in communication with the engine and configured to reduce a compression pressure inside a cylinder of the engine; and
a control device configured to control the first rotary electric machine and the second rotary electric machine during start-up of the engine, the controller configured to operate the pressure reduction device to reduce the compression pressure inside the cylinder during engine start-up.

2. A hybrid vehicle according to claim 1, wherein the control device controls a rotational speed of the engine via the power distribution device by controlling a rotational speed of the first rotary electric machine, and
wherein the control device stops the operation of the pressure reduction device and starts the engine after controlling the first rotary electric machine to increase the engine speed above a predetermined resonance rotational speed of the engine.

3. A hybrid vehicle according to claim 1, wherein the power distribution device comprises a planetary gear train having a first rotary element coupled to the engine, a second rotary element coupled to the first rotary electric machine, and a third rotary element coupled to the second rotary electric machine and to the driving wheel, the first, second and third rotary elements mechanically coupled to each other to distribute power among themselves, and
wherein the control device controls the engine speed via the first and second rotary elements by controlling a rotational speed of the first rotary electric machine when starting up the engine, and controls the second rotary electric machine when power is transmitted from the second rotary element to the first rotary element to prevent power transmission to the third rotary element.

4. A hybrid vehicle according to claim 1, wherein the pressure reduction device operates using a power medium other than hydraulic pressure of the engine.

5. A hybrid vehicle according to claim 3, further comprising:
a vehicle speed detector for detecting a speed of the vehicle, the vehicle speed detector communicating the detected vehicle speed to the control device;
an accelerator opening detector for detecting an opening of an accelerator operated by an operator, the accelerator opening detector communicating the detected accelerator opening to the control device; and
an engine speed detector for detecting the engine speed and communicating the detected engine speed to the control device,
wherein the control device comprises:
a startup determination section for determining whether or not to start up the engine based on the input vehicle speed and accelerator opening;
an engine speed determination section for determining whether or not the input engine speed is higher than a predetermined resonance rotational speed and higher than a proper-for-startup rotational speed proper for engine startup;
an engine control section for controlling the operation of the engine, including operation of the pressure reduction device, operation of a throttle valve of the engine, and operation of an ignition device for igniting the engine;
a first and a second rotary electric machine control section for respectively controlling the first and the second rotary electric machine; and
a drive command section configured to receive inputs from the startup determination section, the engine speed determination section, and the various information input to the control device, the drive command section configured to output a drive command to the first and the second rotary electric machine control sections and to the engine control section based on an operating condition of the vehicle, so as to drive the first and second rotary electric machines and engine in parallel with each other,
wherein, when the startup determination section determines to start the engine, the drive command section outputs a drive command to cause the first rotary electric machine control section to control the rotational speed of the first rotary electric machine, to cause the engine control section to reduce the pressure via the pressure reduction device and close the throttle valve of the engine from the moment when cranking of the engine is started, and to cause the second rotary electric machine control section to control the second rotary electric machine so as to prevent power transmission from the second rotary element to the third rotary element until the engine speed determination section determines that the engine speed is higher than the resonance rotational speed,
wherein, when the engine speed determination section determines that the engine speed is higher than the resonance rotational speed, the drive command section outputs a drive command to cause the engine control section to reduce the pressure through the pressure reduction device and gradually open the throttle valve, and to cause the first rotary electric machine control section to control the first rotary electric machine so as to make the engine speed higher than the proper-for-startup rotational speed until the engine speed is determined to be higher than the proper-for-startup rotational speed, and
wherein, when the engine speed determination section determines that the engine speed is higher than the proper-for-startup rotational speed, the drive command section outputs a drive command to cause the engine control section to stop the pressure reducing operation of the pressure reduction device and ignite the engine, and stops the drive command output to the second rotary electric machine control section for preventing power transmission by the second rotary electric machine.

6. A hybrid vehicle according to claim 5, wherein a current consumed when the first rotary electric machine is being driven by the first rotary electric machine control section is larger when the engine speed is between 0 and the resonance rotational speed than when the engine speed is between the resonance rotational speed and the proper-for-startup rotational speed.

7. A hybrid vehicle having an internal combustion engine and an electric motor as power sources in which a driving wheel is driven by at least one of the engine and the motor, comprising:
a control device that controls operation of the motor and startup of the engine when the motor is driven; and
a pressure reduction device provided in the engine for reducing a compression pressure inside a cylinder of the engine during engine startup, the control device driving the pressure reduction device when starting up the engine to reduce the compression pressure inside the cylinder from a moment when the cranking of the engine is started.

8. A method for operating a hybrid vehicle having an internal combustion engine and an electric motor as power sources in which a driving wheel is driven by at least one of the engine and the motor, the method comprising:
detecting a speed of the hybrid vehicle;
detecting an accelerator position;
detecting a speed of an engine of the hybrid vehicle determining whether to start-up the engine based on the detected vehicle speed and accelerator position;
determining whether or not the detected engine speed is higher than a predetermined resonance rotational speed of the engine, and higher than a proper-for-startup rotational speed proper for engine startup; and
communicating one or more drive commands when the startup of the engine is determined to control a rotational speed of a first rotary electric machine to reduce pressure in a cylinder of the engine and to close a throttle valve of the engine from the moment when cranking of the engine is started, and to control a second rotary electric machine to prevent power transmission from a second rotary element to a third rotary element until the detected engine speed is determined to be higher than the resonance rotational speed.

9. The method of claim 8, further comprising communicating one or more drive commands when the detected engine speed is determined to be higher than the resonance rotational speed to reduce the pressure in the cylinder and gradually open the throttle valve, and to control the first rotary electric machine to increase the engine speed above the proper-for-startup rotational speed until the detected engine speed is determined to be higher than the proper-for-startup rotational speed.

10. The method of claim 9, further comprising communicating one or more drive commands when the detected engine speed is determined to be higher than the proper-for-startup rotational speed to stop the pressure reducing operation in the cylinder and ignite the engine, and to prevent power transmission by the second rotary electric machine.
